(19) United States
(12) Patent Application Publication
(10) Pub. No.: US 2025/0102154 A1
(43) Pub. Date: Mar. 27, 2025

(54) AIR SUPPLY ASSEMBLY, AIR CONDITIONER OUTDOOR UNIT AND AIR CONDITIONER

(71) Applicants: GD MIDEA HEATING & VENTILATING EQUIPMENT CO., LTD., FOSHAN (CN); HEFEI MIDEA HEATING & VENTILATING EQUIPMENT CO., LTD., HEFEI (CN)

(72) Inventors: Dongdong YU, FOSHAN (CN); Yandong WU, FOSHAN (CN); Yuefei LI, FOSHAN (CN); Lihua MA, FOSHAN (CN)

(21) Appl. No.: 18/889,349

(22) Filed: Sep. 18, 2024

(30) Foreign Application Priority Data
Sep. 25, 2023 (CN) 202311245879.1

(51) Int. Cl. F24F 1/0018; F24F 1/0011; F24F 13/08; F24F 13/20; F24F 13/30

(52) U.S. Cl. CPC F24F 1/0018; F24F 1/0011; F24F 13/20; F24F 13/30; F24F 2013/088

(57) ABSTRACT

The present application provides an air supply assembly, an air conditioner outdoor unit, and an air conditioner. The air supply assembly includes: a fan, which includes at least one fan blade having a rear edge of the fan blade and an outer edge of the fan blade; in which the outer edge of the fan blade is located on a side away from a rotational axis of the fan, and the rear edge of the fan blade is connected to the outer edge of the fan blade; the orientation of the rear edge of the fan blade is opposite to a rotational direction of the fan, and a vortex disturbing structure is provided on the rear edge of the fan blade; and a flow guide member having a flow guide channel; in which the flow guide channel is sleeved on an outer side of the fan.

### CROSS-REFERENCES TO RELATED APPLICATIONS

The present application claims priority from Chinese patent application No. 202311245879.1, entitled “Air Supply Assembly, Air Conditioner Outdoor Unit and Air Conditioner” filed on Sep. 25, 2023, the entire content of which is incorporated herein by reference.

### FIELD

The present application relates to the field of air conditioning, and relates to an air supply assembly, an air conditioner outdoor unit, and an air conditioner.

### BACKGROUND

This section only provides background information related to the present disclosure, which is not necessarily the prior art.

In an air conditioning system, aerodynamic noise is one of the main sources of noise during operation of the air conditioning system. When an airflow passes through surfaces of fan blades of the air conditioning system, vortices will be generated. A trailing edge of the fan blade is prone to vortex detachment, which often causes significant pulsation. Periodic vortex detachment will cause changes in the action force exerted by airflow on the object, resulting in vortex noise of fan blade.

### SUMMARY

An object of the present application is to at least solve the problem that vortex noise of fan blade is prone to occurrence in air conditioning systems, and this object is achieved through the following solutions.

One embodiment of the present application provides an air supply assembly, which includes:
a fan, which includes at least one fan blade having a rear edge of the fan blade and an outer edge of the fan blade; in which the outer edge of the fan blade is located on a side of the fan blade that is away from a rotational axis of the fan, and the rear edge of the fan blade is connected to the outer edge of the fan blade; the orientation of the rear edge of the fan blade is opposite to a rotational direction of the fan, and a vortex disturbing structure is provided on the rear edge of the fan blade; and
a flow guide member having a flow guide channel; in which the flow guide channel is sleeved on an outer side of the fan, an inner wall of at least a part of the flow guide channel has a straight cylinder shape, and has a preset gap with the outer edge of the fan blade; the preset gap is used to define movement of an airflow formed on the fan blade in a radial direction of the flow guide channel, and at least most of the vortex disturbing structure is accommodated in the part of the flow guide channel that has the straight cylinder shape.

In the air supply assembly provided by the present application, by providing the vortex disturbing structure at the rear edge of the fan blade of the fan, the vortex formed on the fan blade can be disturbed, and the energy of vortex can be dispersed; moreover, a preset gap is set between the outer edge of the fan blade and the straight cylinder-shaped flow guide channel to prevent the occurrence of vortex detachment from the fan blade, thereby reducing the possibility of vortex noise formation.

In addition, the air supply assembly according to the present application may also have the following additional features.

In some embodiments of the present application, the vortex disturbing structure includes multiple concave portions and multiple convex portions, which are arranged alternately in an extending direction of the rear edge of the fan blade.

In some embodiments of the present application, in a direction of the rotational axis of the fan, the concave portions and the convex portions have a height difference, and all of the multiple concave portions are accommodated in the part of the flow guide channel that has the straight cylinder shape.

In some embodiments of the present application, the vortex disturbing structure is configured into a serrated shape.

In some embodiments of the present application, in a direction of the rotational axis of the fan, the size of the vortex disturbing structure is L1, and the length of the vortex disturbing structure accommodated in the part of the flow guide channel that has the straight cylinder shape is L2, where L2/L1 is larger than 0.8.

In some embodiments of the present application, the fan blade has a first end and a second end in a direction of the rotational axis of the fan; and
the first end is located in an edge area at one end of the straight cylinder-shaped flow guide channel, and the second end is located in an edge area at the other end of the straight cylinder-shaped flow guide channel.

In some embodiments of the present application, the preset gap is any value between 5 mm and 15 mm.

In some embodiments of the present application, the flow guide channel includes an inlet section, an outlet section, and a middle section; the middle section is located between the inlet section and the outlet section, and is configured into a straight cylinder shape; in a direction from the inlet section to the outlet section, an inner diameter of the outlet section gradually increases, and in the direction from the inlet section to the outlet section, an inner diameter of the inlet section gradually decreases.

In some embodiments of the present application, the outlet section is provided with a first noise reduction structure, and most of the serrated vortex disturbing structure is accommodated in the middle section.

In some embodiments of the present application, the inlet section is provided with a second noise reduction structure.

In some embodiments of the present application, an outer wall of the flow guide member is provided with reinforcing ribs.

In some embodiments of the present application, the outer wall of the flow guide member includes multiple transverse ribs and multiple longitudinal ribs; the multiple transverse ribs are spaced apart in a direction of the rotational axis of the fan, the multiple longitudinal ribs are spaced apart in a circumferential direction of the flow guide member, and the transverse ribs and the longitudinal ribs intersect on the outer wall of the flow guide member.

One embodiment of the present application also provides an air conditioner outdoor unit, which includes:
a first housing, which is provided with a first air outlet and a first air inlet, the first air outlet being provided at the top of the housing; and
the air supply assembly as described in any one of the above items, the air supply assembly being provided inside the first housing and having a rotational axis, and the air supply assembly further having an air outlet that is arranged opposite to the first air outlet.

In some embodiments of the present application, the air conditioner outdoor unit further includes a heat exchanger assembly which is provided below the first housing; the heat exchanger assembly encloses a heat exchange air duct, and the heat exchange air duct is communicated with the first air inlet.

In some embodiments of the present application, the air conditioner outdoor unit further includes:
a second housing, the heat exchanger assembly being arranged on a side wall of the second housing; and
an electric control box assembly, which is arranged on the side wall of the second housing, and which encloses the heat exchange air duct together with the heat exchanger.

In some embodiments of the present application, the air conditioner outdoor unit further includes:
a mesh cover, which is arranged at the first air outlet of the first housing, and which has a grille structure that is arranged opposite to the fan; and
the air supply assembly further includes a driving assembly, which is connected to the grille structure, a driving shaft of the driving assembly being connected to the fan.

In some embodiments of the present application, the first housing includes a first side wall portion arranged around the rotational axis, which is configured in a cylindrical configuration with upper and lower openings along the rotational axis; the upper opening of the first side wall portion is configured as the air outlet, and the lower opening of the first side wall portion is configured to receive air after heat exchange with the heat exchanger assembly; and
the mesh cover is installed at the upper opening of the first side wall portion, a back side of the mesh cover faces an internal space defined by the first side wall portion, and the fan is installed on a lower side of the mesh cover.

In some embodiments of the present application, the first side wall portion includes multiple support portions, which are arranged at the upper opening of the first side wall portion, and which are configured to jointly support the mesh cover; and
the multiple support portions are located in a same first plane, which is perpendicular to the rotational axis; the first plane is lower than an upper edge of the first side wall portion to form a concave space, and the grille is accommodated in the concave space and fixedly installed on the multiple support portions.

In some embodiments of the present application, an inner wall of the flow guide member encloses the flow guide channel with upper and lower openings, and an edge of the upper opening of the flow guide member is formed with multiple upper installation portions; and
the first side wall portion includes multiple support portions, which are arranged at the upper opening of the first side wall portion; lower sides of the multiple support portions are correspondingly fixed to the multiple upper installation portions respectively, and upper sides of the multiple support portions are configured to jointly support the mesh cover.

In some embodiments of the present application, the second housing includes a second side wall portion arranged around the rotational axis, which is configured in a cylindrical configuration with upper and lower openings along the rotational axis; a bottom wall is installed at the lower opening of the second side wall portion, and the bottom wall supports the heat exchanger assembly; the upper opening of the second side wall portion corresponds to the lower opening of the first side wall portion.

In some embodiments of the present application, the second side wall portion has a ventilation side wall, which surrounds an outer side of the heat exchanger assembly and which has multiple ventilation holes corresponding to the heat exchanger assembly; the air supply assembly drives external air to pass through the multiple ventilation holes and exchange heat with the heat exchanger assembly, and the air after heat exchange enters the air supply assembly and flows out from the air outlet.

In some embodiments of the present application, the air conditioner outdoor unit further includes the electric control box assembly, which includes a partition, a circuit board installed on the partition, and a cover connected to the partition and covering the circuit board; and
the ventilation side wall has a rectangular shape and forms an opening at the corner; the partition covers the opening of the ventilation side wall, and the cover and the ventilation side wall are configured into a complete rectangular shape.

In some embodiments of the present application, a housing wall of the first housing is recessed toward the internal cylindrical space to form multiple groove portions, each of the groove portions having a groove bottom wall along the recessed direction, a first groove wall connected to a lower side of the groove bottom wall, and a second groove wall connected to an upper side of the groove bottom wall; and
the first housing is installed onto the second housing from top to bottom, and an upper end of the second housing is inserted into the lower opening of the first housing and is configured as a bearing surface to bear the first groove walls of the multiple groove portions.

In some embodiments of the present application, a lower edge of the first housing is provided with multiple first fixing holes, the upper end of the second housing is provided with multiple second fixing holes, and the multiple first fixing holes are respectively fixed to the multiple second fixing holes in a one-to-one correspondence.

In some embodiments of the present application, an inner wall of the flow guide member encloses the flow guide channel with upper and lower openings, and an outer side of the flow guide member is provided with multiple side installation portions; the groove bottom wall of each of the groove portions is correspondingly provided with at least one installation hole, and the multiple side installation portions are respectively fixed to the multiple installation holes in a one-to-one correspondence.

One embodiment of the present application also provides an air conditioner, which includes the air conditioner outdoor unit provided in the embodiments of the present application and an indoor unit, and the indoor unit and the air conditioner outdoor unit are communicated through a gas pipe and a liquid pipe to form a refrigerant circulation system; and
the air conditioner outdoor unit includes a compressor, the heat exchanger assembly, and a gas-liquid separator; one end of the heat exchanger assembly is connected to an exhaust port of the compressor, and the other end of the heat exchanger assembly is connected to the liquid pipe; one end of the gas-liquid separator is connected to an air return port of the compressor, and the other end of the gas-liquid separator is connected to the gas pipe.

### BRIEF DESCRIPTION OF THE DRAWINGS

Upon reading the detailed description of the embodiments below, various other embodiments will become clear. The accompanying drawings are only used for the purpose of illustrating some embodiments, and should not be considered as a limitation to the present application. Moreover, throughout the drawings, the same reference signs are used to denote the same components. In the drawings:

FIG. 1 is a schematic structural view of the air supply assembly according to an embodiment of the present application;

FIG. 2 is an enlarged view of part B in FIG. 1;

FIG. 3 is a schematic structural view of the air supply assembly according to an embodiment of the present application;

FIG. 4 is a cross-sectional view seen from direction D-D in FIG. 3;

FIG. 5 is a schematic structural view of a flow guide member of the air supply assembly according to an embodiment of the present application;

FIG. 6 is a cross-sectional view seen from direction C-C in FIG. 5;

FIG. 7 is a perspective view of the flow guide member of the air supply assembly according to an embodiment of the present application;

FIG. 8 is a schematic structural view of the air supply assembly of an air conditioner outdoor unit according to an embodiment of the present application;

FIG. 9 is a schematic structural view of the air conditioner outdoor unit according to an embodiment of the present application;

FIG. 10 is a schematic structural view of a first housing of the air conditioner outdoor unit according to an embodiment of the present application;

FIG. 11 is a schematic structural view of a second housing of the air conditioner outdoor unit according to an embodiment of the present application;

FIG. 12 is a partial schematic structural view of the air conditioner outdoor unit according to an embodiment of the present application, showing an internal structure of the air conditioner outdoor unit;

FIG. 13 is a schematic view of an exploded structure of the air conditioner outdoor unit according to an embodiment of the present application.

FIG. 14 is a schematic structural view of a heat exchanger unit according to an embodiment of the present application;

FIG. 15 is a schematic structural view of a fan unit according to an embodiment of the present application;

FIG. 16 is a schematic enlarged view of a partial structure at part A in FIG. 14;

FIG. 17 is a schematic sectional structural view of the fan unit according to an embodiment of the present application;

FIG. 18 is a schematic enlarged view of a partial structure at part B in FIG. 17;

FIG. 19 is a schematic sectional structural view of the heat exchanger unit according to an embodiment of the present application;

FIG. 20 is a schematic enlarged view of a partial structure at part C in FIG. 19;

FIG. 21 is a schematic enlarged view of a partial structure at the connection between the first housing and the second housing;

FIG. 22 is a schematic view of an exploded structure of the air conditioner outdoor unit according to an embodiment of the present application;

FIG. 23 is a schematic view of an exploded structure of the fan unit according to an embodiment of the present application;

FIG. 24 is a schematic view of the airflow direction of the air conditioner outdoor unit according to an embodiment of the present application;

FIG. 25 is a schematic structural view of an axial flow fan according to an embodiment of the present application; and

FIG. 26 is a schematic view of a system structure of the HVAC system according to an embodiment of the present application.

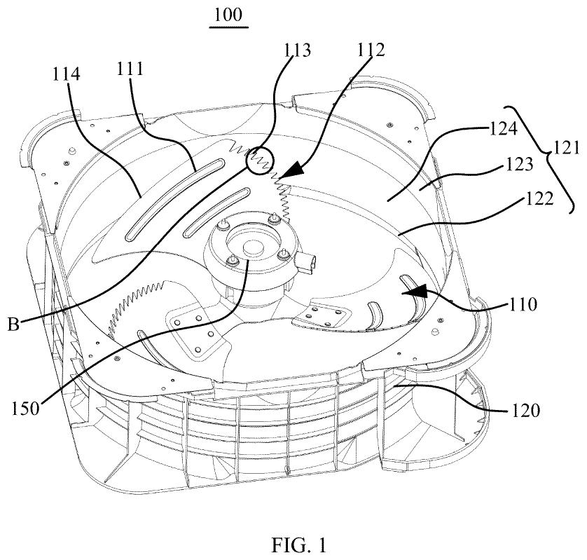

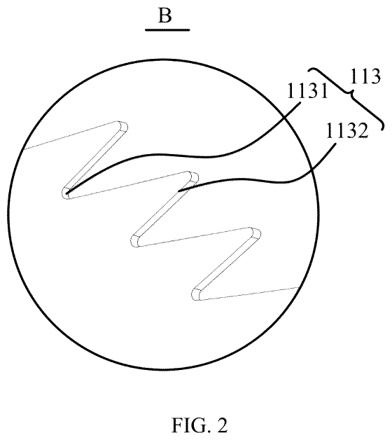

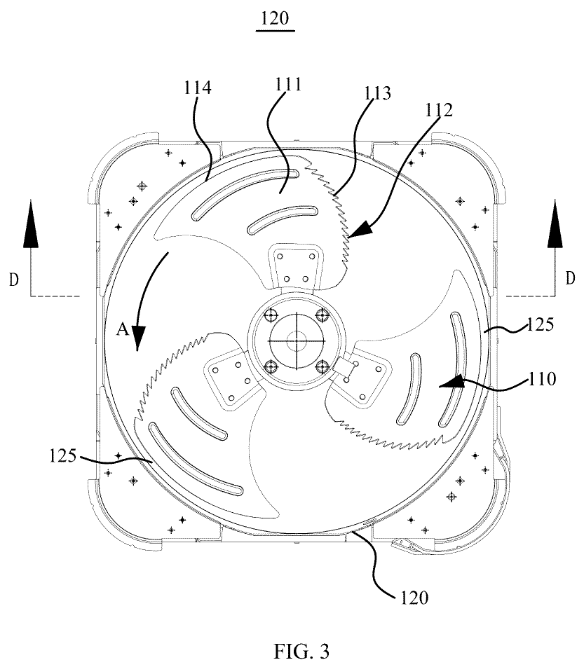

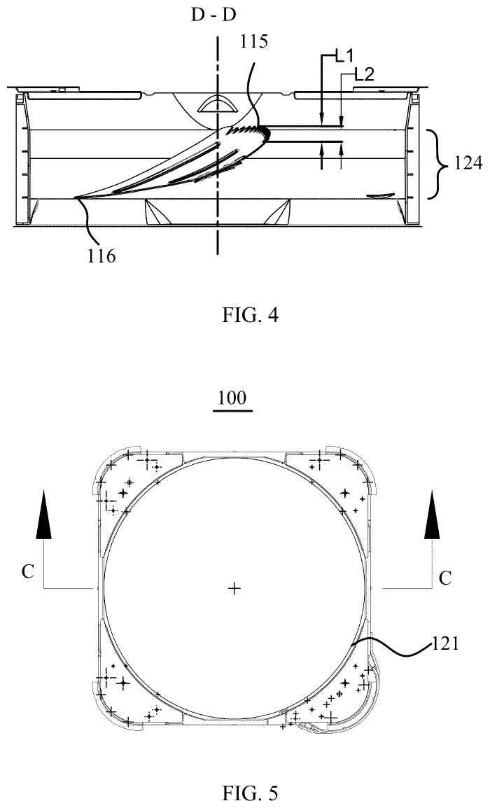

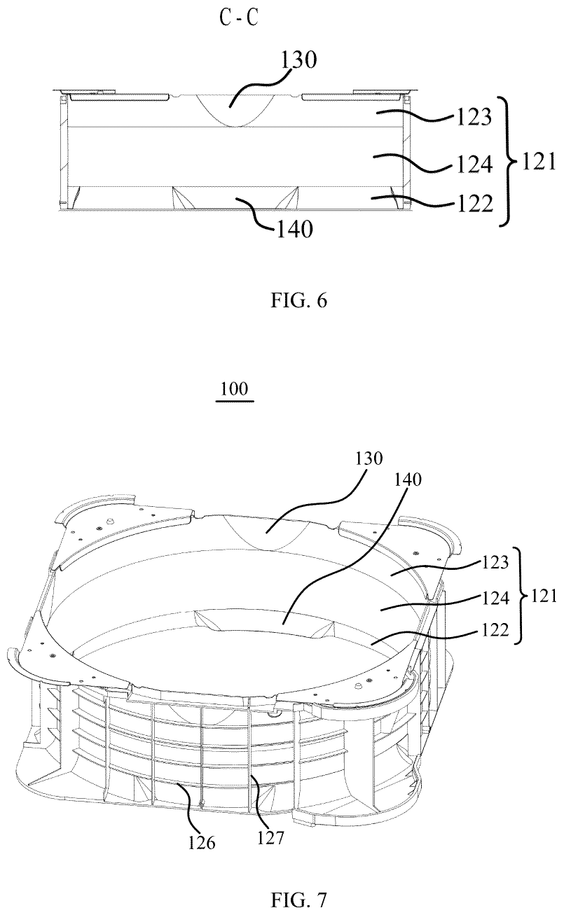

### LIST OF REFERENCE SIGNS

100: air supply assembly;
110: fan; 111: fan blade; 112: rear edge of fan blade; 113: vortex disturbing structure; 1131: concave portion; 1132: convex portion; 114: outer edge of fan blade; 115: first end; 116: second end; A: rotational direction; 117: rotational axis;
120: flow guide member; 121: flow guide channel; 122: inlet section; 123: outlet section; 124: middle section; 125: preset gap; 126: transverse rib; 127: longitudinal rib; 1281: upper installation portion; 1282: side installation portion; 129: installation hole;
150: driving assembly;
130: first noise reduction structure; 140: second noise reduction structure;
200: air conditioner outdoor unit;
210: first housing; 211: first air outlet; 212: first air inlet;
220: heat exchanger assembly; 221: heat exchange air duct;
230: second housing; 231: second air inlet;
240: electric control box assembly; 241: preset distance; 242: partition; 243: circuit board; 244: cover;
250: mesh cover; 251: grille structure;
12: first side wall portion; 13: groove portion; 131: first groove wall; 132: second groove wall; 133: groove bottom wall; 14: first fixing hole; 15: installation plate; 16: support portion; 16a: concave space;
22: second side wall portion; 23: ventilation side wall; 24: ventilation hole; 25: opening; 26: second fixing hole; 27: support surface;
160: air conditioner indoor unit; 161: indoor heat exchanger; 162: compressor; 163: gas-liquid separator; 164: air return pipe; 165: four-way valve; 166: gas pipe; 167: liquid pipe; 168: filter.

### DETAILED DESCRIPTION OF THE DISCLOSURE

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or in operation in addition to the orientation depicted in the drawings. For example, if the device in the figure is turned over, then elements described as “below other elements or features” or “under other elements or features” will be oriented “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

The present application provides an air supply assembly 100, which is suitable for HVAC apparatuses such as air conditioners, especially for outdoor units of HVAC apparatuses. The air supply assembly 100 includes a fan 110 and a flow guide member 120; the flow guide member 120 has a flow guide channel 121 which includes an inlet section 122, an outlet section, and a middle section 124. The middle section 124 is located between the inlet section 122 and the outlet section 123, and is used to cooperate with fan blades 111 of the fan 110 to guide the air and prevent noise formation of airflow on the fan blades 111.

The flow guide channel 121 of the flow guide member 120 is sleeved on an outer side of the fan 110, and there is a preset gap 125 between an inner wall surface of at least part of the flow guide channel 121 and an outer edge 114 of the fan 110. The purpose of setting the preset gap 125 is to prevent the occurrence of vortex detachment on the fan blades 111. In the narrow space of the preset gap 125, vortex cannot detach from the fan blades 111 to cause pressure pulsation, and the formation of vortex noise is prevented.

The preset gap 125 can be set to any value between 5 mm and 15 mm, making the structure between the flow guide member 120 and the fan 110 more compact, while also meeting the guiding effect of the flow guide channel 121 of the flow guide member 120 on the fan 110.

The fan 110 of the air supply assembly 100 of the present application is provided with at least one fan blade 111. In a rotational direction A of the fan 110, the fan blade 111 is formed with a rear edge 112 of the fan blade in the rear edge area, and a vortex disturbing structure 113 is provided on the rear edge 112 of the fan blade. At least most of the vortex disturbing structure 113 is accommodated in the straight cylinder-shaped flow guide channel 121. The vortex disturbing structure 113 provided in the area of the rear edge 112 of the fan blade can prevent the airflow from forming vortices in the area of the rear edge 112 of the fan blade. The vortex disturbing structure 113 can also be set as a structure that can disperse large-scale vortices, thereby dispersing the vortex energy already formed and reducing the aerodynamic noise generated during the rotation of the fan 110.

In an embodiment of the present application, the vortex disturbing structure 113 can be set as a structure having a concave portion 1131 and a convex portion 1132. The concave portion 1131 and the convex portion 1132 provided in the area of the rear edge 112 of the fan blade can cut large-scale low-frequency vortices into small-scale high-frequency vortices, and sound wave energy can be quickly scattered, thus further reducing broadband noise, and thereby reducing the aerodynamic noise generated during the rotation of the axial-flow fan blades.

For the aerodynamic vortex noise involved in the present application, it should be understood as follows: in general, when the airflow passes through an obstacle, due to the influence of the viscous friction of air molecules, the airflow with a certain velocity interacts with the relatively stationary gas behind the obstacle, forming an airflow with vortices in the downstream area of the obstacle. These vortices constantly form and detach, with the pressure at the center of each vortex being lower than the pressure of the surrounding medium. Each time a vortex detaches, a pressure jump occurs in the turbulent airflow. The jumping pressure propagates outward through the surrounding medium and acts on the obstacle. When the pressure pulsation in the turbulent airflow contains audible audio components having an intensity strong enough, noise is radiated, known as vortex noise or turbulence noise.

In the air supply assembly 100 of the embodiment of the present application, most of the vortex disturbing structure 113 on the rear edge 112 of the fan blade is accommodated in the straight cylinder-shaped flow guide channel 121, and a preset gap 125 is provided between the outer edge 114 of the fan blade 111 and the inner wall surface of the straight cylinder-shaped flow guide channel 121. On one hand, the vortex disturbing structure 113 can disperse the vortices already formed, and on the other hand, the preset gap 125 can prevent vortex detachment, thereby reducing the possibility of aerodynamic noise.

In an embodiment of the present application, the straight cylinder-shaped flow guide channel 121 can be provided as the middle section 124 of the flow guide member 120; the straight cylinder shape means that in the axis direction of the flow guide channel 121, there is no undulation on the inner wall surface of the flow guide channel 121, and an inner diameter of the flow guide channel 121 in this section is consistent, also known as “linear section”. The middle section 124 can be completely set as the straight cylinder-shaped flow guide channel 121, with the inlet section 122 provided at one end of the middle section 124 and the outlet section 123 provided at the other end of the middle section 124; it is also possible to set part of the axial portion of the middle section 124 as having the straight cylinder shape.

In the air supply assembly 100 of the embodiment of the present application, most of the vortex disturbing structure 113 of the fan blade 111 can be accommodated in the straight cylinder-shaped flow guide channel 121, and the straight cylinder-shaped inner wall of the middle section 124 plays a guiding role in diffusing the airflow, and noise formation can be greatly reduced within the preset gap 125.

It should be noted that for the airflow noise of the fan 110, vortex detachment on the rear edge of the fan blade 111 is an important factor in the noise generation of the fan. Periodic vortex detachment will lead to changes in the corresponding circulation, which refers to the volume occupied by the fluid passing through a closed path within a specified time.

In some embodiments of the present application, the vortex disturbing structure 113 on the rear edge 112 of the fan blade includes multiple concave portions 1131 and multiple convex portions 1132, which are arranged alternately, and all of the multiple concave portions 1131 are accommodated in the straight cylinder-shaped flow guide channel 121. In this embodiment, the vortices already formed can be better dispersed between the alternately arranged concave portions 1131 and convex portions 1132. The convex portions 1132 and the concave portions 1131 can extend outward along the rear edge 112 of the fan blade, or can extend along the arc-shaped fan surface of the fan blade 111. The concave portions 1131 and the convex portions 1132 should be smoothly connected to the fan blade 111, which is advantageous for the flow of airflow on the surface of the fan blade 111.

In this embodiment, all of the concave portions 1131 are accommodated in the straight cylinder-shaped flow guide channel 121, and all the vortices can enter the preset gap 125 between the outer edge 114 of the fan blade and the inner wall surface of the flow guide member 120 after passing through the concave portions 1131. Under the guidance of the flow guide member 120, the vortices flow toward the outlet of the air supply assembly 100. Since the outlet section 123 of the flow guide member 120 is connected to the middle section 124, the concave portions 1131 confined in the straight cylinder-shaped flow guide section can prevent the vortices from entering the outlet section 123 to cause airflow fluctuation and further generate aerodynamic noise, especially when the outlet section 123 of the flow guide member 120 is configured into a trumpet shape.

In one embodiment, the concave portions 1131 and the convex portions 1132 can be wave-shaped structures formed on the rear edge 112 of the fan blade. In order to make the airflow flow smoother and improve the flow efficiency of the airflow, the vortex disturbing structure 113 is arranged to extend outward along the arc-shaped surface of the fan blade 111, and the extending direction is consistent with the flow direction of the airflow on the surface of the fan blade 111 during the rotation of the fan 110. Moreover, under the disturbance of the alternately arranged concave portions 1131 and convex portions 1132, the energy of the vortex is dispersed. All the concave portions 1131 are accommodated in the middle section 124 of the flow guide member 120, and the airflow passing through the concave portions 1131 can be confined in the flow guide channel 121 with a straight cylinder-shaped inner wall to prevent noise caused by airflow fluctuation.

In this embodiment, the inner wall of the middle section 124 of the flow guide member 120 can be configured into a straight cylinder shape, and a preset gap is set between the inner wall surface and the outer edge 114 of the fan 110 or the outer edge 114 of the fan blade, which can prevent the airflow on the fan blade 111 from having large fluctuations after passing through the vortex disturbing structure 113; the inner diameter of the middle section 124 is consistent, which prevents the airflow from fluctuating in the radial direction, thus reducing noise.

In some embodiments of the present application, the multiple adjacent concave portions 1131 and convex portions 1132 are configured into a serrated shape and formed on the rear edge 112 of the fan blade along the edge of the fan blade 111. In this embodiment, in the vortex disturbing structure 113 on the rear edge 112 of the fan blade, the alternately arranged concave portions 1131 and convex portions 1132 are configured into a serrated shape, with tooth tips extending along the fan surface in consistency with the flow direction of the airflow to improve the flow efficiency of the airflow. The serrated vortex disturbing structure 113 can also be arranged in the radial direction of the fan 110, which can increase the area of the flow guide structure on the rear edge 112 of the fan blade, thereby increasing the contact area between the vortex disturbing structure 113 and the airflow and reducing vortex detachment on the surface of the fan blade 111.

In the air supply assembly 100 of the embodiment of the present application, by providing the serrated structure on the rear edge of the fan blade 111, wake flow is improved, and large-scale low-frequency vortices are cut into small-scale high-frequency vortices, and sound wave energy can be quickly scattered, thus further reducing broadband noise, and thereby reducing the aerodynamic noise generated during the rotation of the axial-flow fan blades.

In some embodiments of the present application, in the rotational axis direction of the fan 110, the length of the vortex disturbing structure 113 is L1, and the length of the vortex disturbing structure accommodated in the straight cylinder-shaped flow guide channel 121 is L2, where L2/L1 is larger than 0.8. In this embodiment, in the rotational direction A of the fan 110, 80% of the length of the vortex disturbing structure 113 is provided in the straight cylinder-shaped flow guide channel 121 of the flow guide member 120, and most of the airflow of the fan blade 111 is confined in the straight cylinder-shaped flow guide channel 121 after passing through the vortex disturbing structure 113. Due to the limitation of the straight cylinder-shaped flow guide channel 121, the airflow is prevented from having large fluctuations in the radial direction of the flow guide member 120, thereby avoiding further noise generated by vortices.

In some embodiments of the present application, the inner wall of the middle section 124 of the flow guide member 120 has a straight cylinder shape, and the preset gap 125 between the outer edge 114 of the fan blade of the fan 110 and the inner wall surface of the middle section 124 is any value between 5 mm and 15 mm. For reducing airflow noise, the preset gap 125 should be as small as possible. Considering the actual situation of the flow guide member 120, such as installation accuracy and size limitations between the fan and the flow guide member 120, the preset gap can be set to any value in the above range.

In some embodiments of the present application, the fan blade 111 has a first end 115 in a first direction and a second end 116 in a second direction. Both the first direction and the second direction are along the rotational axis direction of the fan 110 and are opposite to each other. The first end 115 is located in the edge area on one side of the straight cylinder-shaped flow guide channel 121, and the second end 116 is located in the edge area on the other side of the straight cylinder-shaped flow guide channel 121. The axial distance of the fan 110 of the air supply assembly 100 in this embodiment is approximately the same as the axial distance of the straight cylinder-shaped flow guide channel 121 of the flow guide member 120; that is, in the rotational axis direction of the fan 110, the two ends of the fan blade 111 are located in the edge areas of the middle section 124.

In this embodiment, the two ends of the fan blade 111 of the fan 110 in the rotational axis direction are substantially located in the edge areas of the middle section 124 of the flow guide member 120, and the airflow is mostly confined within the middle section 124 of the flow guide member 120 by the rear edge 112 of the fan blade. Therefore, the airflow can be prevented from fluctuating in the radial direction of the flow guide member 120, thereby further avoiding the generation of noise.

The edge areas of the straight cylinder-shaped flow guide channel refer to areas connected to the straight cylinder-shaped flow guide channel. For example, when the flow guide channel includes the inlet section, the outlet section, and the middle section which is the straight cylinder-shaped flow guide channel and also connected to the inlet section and the outlet section, the edge areas of the straight cylinder-shaped flow guide channel are the connection area between the middle section and the inlet section as well as the connection area between the middle section and the outlet section.

As to the sources of noise in the air supply assembly 100 of the present application, one is the pressure pulsation generated at the wake of the airflow after the vortex detaches from the fan blade 111, which produces noise when acting on the air supply assembly 100; the other is the fluctuation of the airflow in the radial direction of the flow guide member 120 after the airflow detaches from the rear edge 112 of the fan blade.

In some embodiments of the present application, the flow guide channel 121 includes the inlet section 122, the outlet section 123, and the middle section 124. The middle section 124 is located between the inlet section 122 and the outlet section 123, and the straight cylinder-shaped flow guide channel 121 is located in the middle section 124. Both the outlet section 123 and the inlet section 122 have a trumpet shape, with the trumpet shape of the outlet section 123 expanding outward and the trumpet shape of the inlet section 122 expanding outward.

In this embodiment, both the outlet section 123 and the inlet section are configured into a trumpet shape, which can diffuse the airflow and increase the flow area of the airflow, thereby improving the guiding ability of the flow guide member 120 for the airflow.

In some embodiments of the present application, the outlet section 123 is provided with a first noise reduction structure 130, which is connected to the middle section 124. Most of the serrated vortex disturbing structure 113 is accommodated in the middle section 124. By providing the first noise reduction structure 130 at the outlet section 123 of the flow guide member 120, when the fan 110 rotates, the regular interference frequency of the driven airflow with surrounding objects is increased, and the frequency of the low-frequency noise accumulated by the rotation of the fan 110 is increased. The spikes of the rotating noise in the same frequency band are reduced, thereby reducing the low-frequency noise during use and effectively improving the user experience.

The first noise reduction structure 130 can be a protruding part provided on the inner wall surface of the outlet section 123, or a cut-out part, or a combination of a protruding part and a cut-out part. The cut-out part provided on the inner wall surface of the outlet section 123 has a flat surface smoothly connected to the inner wall surface. The connection between the flat surface and the inner wall surface can be linear, or arc shaped, or curve shaped. When the airflow flows from the inner wall surface of the outlet section 123 to the cut-out part, since the distance in the direction perpendicular to the rotational axis of the fan 110 changes, that is, the radial distance changes, the interference on the airflow is increased, and the spikes of the rotating noise in the same frequency band are reduced, thereby reducing the airflow noise. When multiple cut-out parts are provided on the inner wall surface of the outlet section 123, or uniformly arranged in the axial direction of the flow guide member 120, the airflow can be subject to periodic interference on the inner wall surface of the outlet section 123, and the noise spikes in the airflow are reduced more significantly.

The protruding part arranged on the inner wall surface of the outlet section 123 has an arc-shaped wall surface and is smoothly connected to the inner wall surface of the outlet section 123. Due to the protruding part arranged on the inner wall of the outlet section 123, when the airflow flows from the inner wall surface of the outlet section 123 to the arc-shaped wall surface of the protruding part, the distance in the direction perpendicular to the axial direction of the flow guide member 120 changes, that is, the radial distance changes, causing interference on the circulation of airflow and reducing the spikes of the rotating noise in the same frequency band, thereby reducing the airflow noise.

In some embodiments of the present application, a second noise reduction structure 140 can be provided in the inlet section of the flow guide member 120, and the second noise reduction structure 140 is connected to the middle section 124 of the flow guide member 120. The second noise reduction structure can be a cut-out part, or a protruding part, or a combination of a cut-out part and a protruding part. Similar to the effect of the first noise reduction structure 130 in the outlet section, the airflow is subject to regular interference. When multiple cut-out parts or protruding parts are provided, the frequency of interference on the airflow is increased, the frequency of the low-frequency noise accumulated by the rotation of the fan 110 is increased, and the spikes of the rotating noise in the same frequency band are reduced, thereby reducing the low-frequency noise during use.

In some embodiments of the present application, multiple transverse ribs 126 and multiple longitudinal ribs 127 are also provided on the outer wall of the flow guide member 120. The transverse ribs 126 and the longitudinal ribs 127 can improve the connection stiffness of the flow guide member 120. When the fan 110 rotates at a high speed, even if it is impacted by airflow, the flow guide member 120 will not vibrate. The multiple transverse ribs 126 are spaced apart, and the multiple longitudinal ribs 127 are spaced apart. The transverse ribs 126 and the longitudinal ribs 127 are staggered on the outer wall of the flow guide member 120, which can further improve the strength of the flow guide member 120. According to the actual situation, the outer wall of the flow guide member 120 can be configured as a circular structure, a square structure, etc.

The present application also provides an air conditioner outdoor unit 200, which includes a first housing 210, and the air supply assembly 100 as described in any one of the above items. The air supply assembly 100 is arranged inside the first housing 210, and the first housing 210 is provided with a first air inlet 212 and a first air outlet 211. The first air outlet 211 is arranged at the top of the first housing 210, and the first air outlet 211 of the first housing 210 is arranged opposite to the air outlet of the air supply assembly 100, and the first housing 210 and the air supply assembly 100 form an independent air supply module.

The air conditioner outdoor unit 200 further includes a heat exchanger assembly 220, and a heat exchanger is arranged below the air supply module. The heat exchanger assembly 220 encloses a heat exchange air duct 221, which is communicated with the first air inlet 212 of the first housing 210. In this embodiment, the air conditioner outdoor unit 200 adopts a top air supply structure, and the air supply module is arranged above the heat exchanger assembly 220.

In some embodiments of the present application, the air conditioner outdoor unit 200 further includes a second housing 230, and the heat exchanger in the heat exchanger assembly 220 extends along a side wall of the second housing 230. A second air inlet 231 is further provided on the second housing 230, and the second air inlet 231 is arranged opposite to the heat exchanger. In this embodiment, the second housing 230 and the heat exchanger assembly 220 form a heat exchange module, which is arranged below the air supply module. An airflow circulation path is formed between the second air inlet 231 of the second housing 230 and the first air outlet 211 of the first housing 210, and the airflow passes through at least the heat exchanger, the heat exchange air duct 221, the fan, and the flow guide member 120.

The air conditioner outdoor unit 200 further includes an electric control box assembly 240, and an opening structure is provided on one side of the heat exchange air duct 221 enclosed by the heat exchanger. The electric control box assembly 240 is arranged in the opening structure, and the heat exchange air duct 221 and the electric control box assembly 240 together enclose the heat exchange air duct 221.

In some embodiments of the present application, the electric control box assembly 240 has a partition 242, a circuit board 243, and a radiator. The partition 242 and the heat exchanger assembly 220 enclose at least part of the heat exchange air duct 221. The circuit board 243 is installed on an outer plate surface of the partition 242 that faces away from the heat exchange air duct 221, and the radiator is located inside the heat exchange air duct 221 and installed on an inner plate surface of the partition 242 that faces the heat exchange air duct 137. An avoidance hole on the partition 242 allows the radiator to be thermally conducted to the circuit board 243. The airflow in the heat exchange air duct 137 passes through the radiator, and when viewed in an extending direction of a rotational axis 117, a rotational surface overlaps with the radiator.

In some embodiments of the present application, the air conditioner outdoor unit 200 further includes a mesh cover 250, which is arranged at the position of the first air outlet 211 of the first housing 210. The mesh cover 250 is provided with a grille structure 251, which is arranged opposite to the fan 110. The grille structure 251 is also connected to a driving assembly 150 of the air supply assembly 100. The driving assembly 150 at least includes a driving shaft, which is connected to a hub of the fan 110 for driving the fan 110 to rotate.

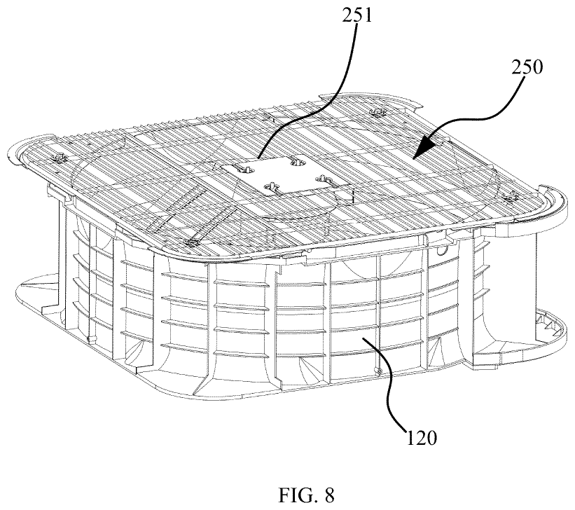

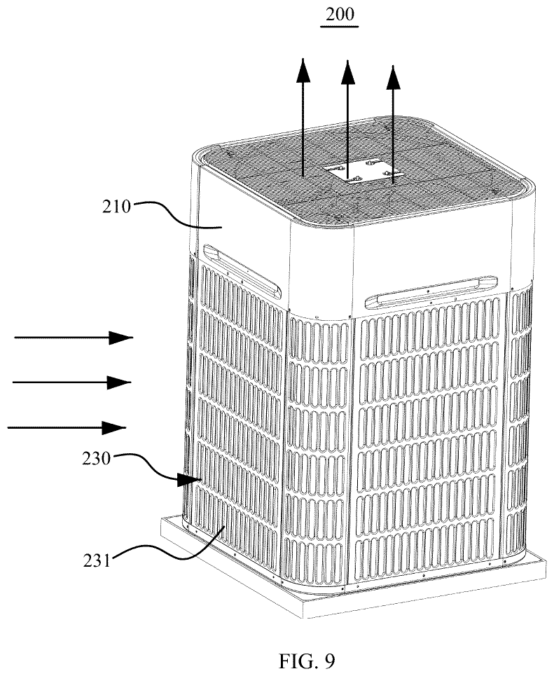

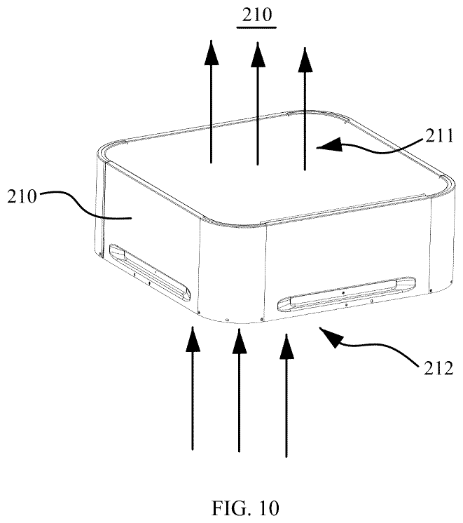

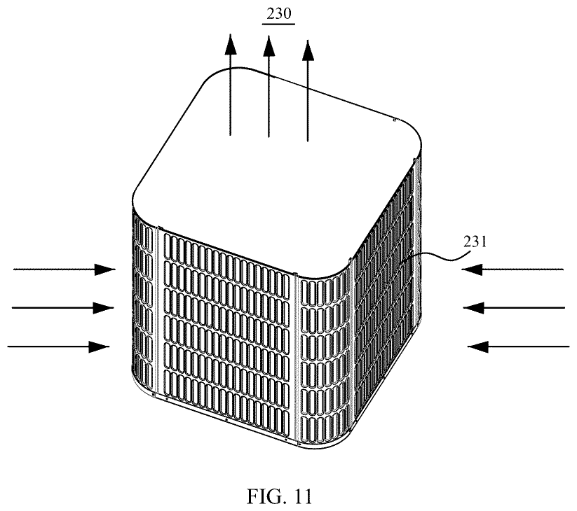

With reference to FIGS. 8-12, in some embodiments of the present application, the air conditioner outdoor unit 200 is configured as a fan unit and a heat exchanger unit. The fan unit 101 includes a first housing 210 and a fan 110 arranged inside the first housing 210. The heat exchanger unit includes a second housing 230 and a heat exchanger assembly 220 arranged inside the second housing 230.

It can be understood that the first housing 210 is detachably connected to the second housing 230, including but not limited to snap-fit connection, slot connection, bolt fixation, and other detachable connection methods. The first housing 210 can have a cylindrical or square cylinder shape, with open upper and lower ends to facilitate communication with the second housing 230 and discharge internal airflow. The fan 110 can be installed inside the first housing 21 by snap-fit or bracket fixation. The second housing 230 can also have a cylindrical or square cylinder shape, with open upper and lower ends to facilitate docking with and internal communication with the first housing 210. The heat exchanger assembly 220 can be installed inside the second housing 230 by bracket fixation. The fan 110 can draw external air into the second housing 230 to exchange heat with the heat exchanger assembly 220 and other components before being discharged from a top end of the first housing 210.

With reference to FIGS. 8, 17 and 18, in some embodiments of the present application, the first housing 210 includes a first side wall portion 12 arranged around the rotational axis 117. The first side wall portion 12 is configured in a cylindrical configuration with upper and lower openings along the rotational axis. The upper opening of the first side wall portion 12 is configured as an air outlet 211, and the lower opening of the first side wall portion 12 is configured to receive the air after heat exchange with the heat exchanger assembly 220. The fan unit includes a mesh cover 250, which is installed at the upper opening of the first side wall portion 12. A back side of the mesh cover 250 faces an internal space defined by the first side wall portion 12, and the fan 110 is installed on a lower side of the mesh cover 250.

It can be understood that the first housing 210 has a cylindrical structure, and the first side wall portion 12 can be a cylindrical structure, or a square cylinder structure formed by connecting four first side plates in sequence. The first side wall portion 12 have upper and lower openings at both ends. The upper opening of the first side wall portion 12 is used to discharge the exhaust gas of the fan 110 to the outside of the first housing 210. The lower opening of the first side wall portion 12 is used to dock and communicate with the second housing 230 to receive the airflow after heat exchange with the heat exchanger assembly 220 inside the second housing 230. The mesh cover 250 is also provided in the upper opening of the first housing 210, and the shape of the mesh cover 250 is adapted to the upper opening. The mesh cover 250 has multiple air holes, and the airflow driven by the fan 110 can be discharged from the mesh cover 250 located downstream of the fan 110 to the outside. The mesh cover 250 also has the function of protecting the interior of a cabinet. In addition, an installation plate 15 is arranged in the middle of the mesh cover 250, and the axial center of the fan 110 can be fixed to the installation plate 15 through a bolt to achieve coaxial connection between the fan 110 and the mesh cover 250.

With reference to FIGS. 8, 17 and 18, in some embodiments of the present application, the first side wall portion 12 includes multiple support portions 16, which are arranged at the upper opening of the first side wall portion 12. The multiple support portions 16 are configured to jointly support the mesh cover 250.

The multiple support portions 16 are located in a same first plane, which is perpendicular to the rotational axis; the first plane is lower than an upper edge of the first side wall portion 12 to form a concave space 16a, and the mesh cover 250 is accommodated in the concave space 16a and fixedly installed on the multiple support portions 16.

It can be understood that the support portions 16 are arranged at an axial end of the first side wall portion 12 that is away from the second housing 230, and the support portions 16 may be formed in the following way: part of the inner wall of the first side wall portion 12 extends inward along the radial direction of the fan 110 to form the support portions 16. The support portion 16 has a support surface 27 on the side facing away from the second housing 230. The support surface 27 can be rectangular for easy processing, or curved to optimize the structure of the air duct. Multiple support portions 16 can be arranged on an inner side of the first side wall portion 12 in a circumferential direction of the fan 110. For example, when the first side wall portion 12 is a square cylinder structure, a support portion 16 can be arranged at each of four corners of the first side wall portion 12 to support the mesh cover 250. At the same time, the support portions 16 can also strengthen the overall strength of the first housing 210, making it less prone to deformation. The connection stability between the support portions 16 and the mesh cover 250 can also be improved by setting bolts or buckles. In addition, an inner edge of each supporting portion 16 and an inner edge of the first side wall portion 12 form a roughly circular air passing hole for rapid airflow.

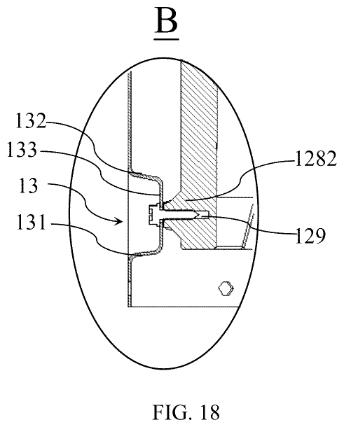

With reference to FIG. 18, in some embodiments of the present application, the fan unit 101 includes a flow guide member 120, and an inner wall of the flow guide member 120 enclose a flow guide channel with upper and lower openings. Multiple upper installation portions 1281 are formed on an edge of the upper opening of the flow guide member 120.

The first side wall portion 12 includes multiple support portions 16, which are arranged at the upper opening of the first side wall portion 12. The lower sides of the multiple support portions 16 are correspondingly fixed to the multiple upper installation portions 1281 respectively; and the upper sides of the multiple support portions 16 are configured to jointly support the mesh cover 250.

It can be understood that the flow guide member 120 can be arranged in the space defined by the first side wall portion 12 to guide the airflow generated by the fan 110 and improve the efficiency of airflow delivery. The flow guide member 120 can be cylindrical and surround an outer peripheral side of the fan 110. The flow guide member 120 defines a flow guide channel with upper and lower openings. The upper opening of the flow guide member 120 corresponds to the mesh cover 250, and the lower opening of the flow guide member 120 is communicated with the upper opening of the second housing 230. The multiple upper installation portions 1281 provided on the edge of the upper opening of the flow guide member 120 are connected to the lower sides of the support portions 16 of the first side wall portion 12, and the flow guide member 120 can be fixed. The upper installation portion 1281 can be a flange structure with an installation hole 129; for example, the upper side of the flow guide member 120 extends radially outward to form a flange, and the flange is provided with an installation hole 129. The installation hole 129 is fixed to a bolt hole on the support portion 16 by a bolt. Multiple installation portions can be arranged at intervals in the circumferential direction of the fan 110; for example, multiple installation portions are arranged corresponding to the multiple support portions 16 arranged at the corners. In addition, multiple reinforcing ribs can also be provided on the flange to enhance the structural strength at this position. Moreover, the upper sides of the support portions 16 are used to fix the mesh cover 250, and the mesh cover 250 can be fixed by the same bolt used for installing the flow guide member 120, making the structure more compact.

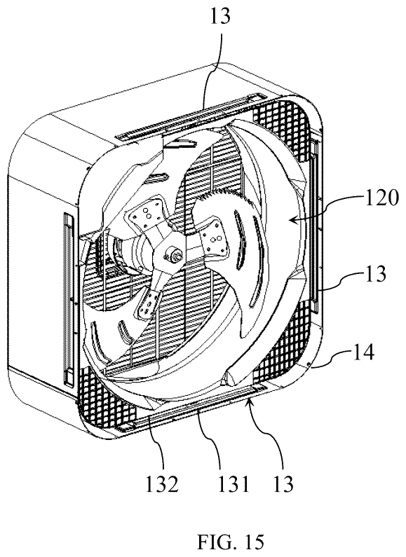

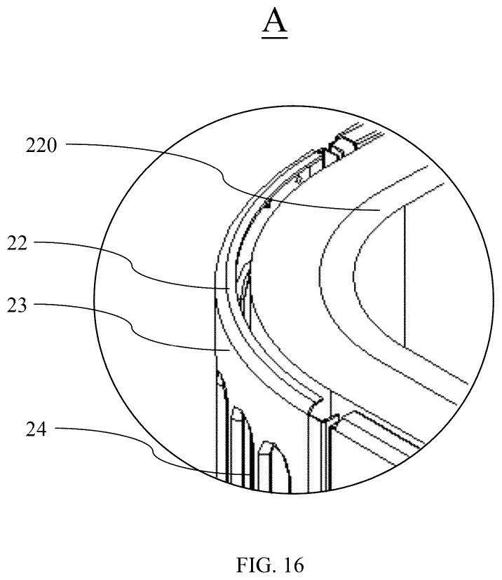

With reference to FIGS. 8 to 18, in some embodiments of the present application, the second housing 230 includes a second side wall portion 22 arranged around the rotational axis 117. The second side wall portion 22 is configured in a cylindrical configuration with upper and lower openings along the rotational axis. A bottom wall is installed at the lower opening of the second side wall portion 22, and the bottom wall supports the heat exchanger assembly 220. The upper opening of the second side wall portion 22 corresponds to the lower opening of the first side wall portion 12.

It can be understood that the second housing 230 can be a cylindrical or square cylinder structure. The second housing 230 is composed of the second side wall portion 22 arranged around the rotational axis 117. The second side wall portion 22 can be composed of multiple second side plates connected in sequence around the rotational axis 117. A space for accommodating the heat exchanger assembly 220 is defined between the multiple second side plates. The upper opening of the second side wall portion 22 is communicated with the lower opening of the first side wall portion 12, and the fan 110 can extract the airflow after heat exchange in the second housing 230. A bottom wall is arranged in the lower opening of the second side wall portion 22, and the shape of the bottom wall is adapted to the lower opening. The bottom wall can have a flat plate structure. Structures such as a bracket or buckle can be arranged on the side of the bottom wall that faces the first housing 210 to fix the heat exchanger assembly 220.

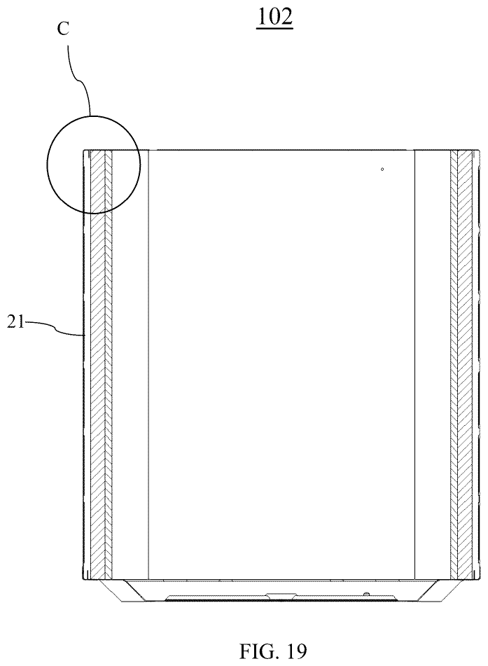

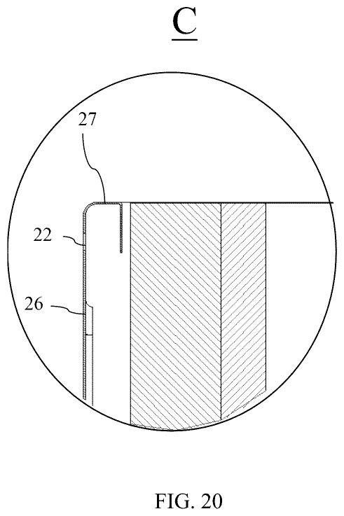

With reference to FIGS. 8, 10 and 17 to 19, in some embodiments of the present application, the second side wall portion 22 has a ventilation side wall 23 that surrounds the outer side of the heat exchanger assembly 220. The ventilation side wall 23 has multiple ventilation holes 24 corresponding to the heat exchanger assembly 220. The fan unit 101 drives external air to pass through the multiple ventilation holes 24 and exchange heat with the heat exchanger assembly 220. The air after heat exchange enters the fan unit 101 from the heat exchanger unit 102 and flows out from the air outlet 211.

It can be understood that the ventilation side wall 23 can be arranged on the second side wall portion 22 corresponding to the position of the heat exchanger assembly 220. The ventilation side wall 23 has multiple ventilation holes 24, which can be rectangular or circular and arranged in an array to improve the ventilation effect. The fan unit 101 can drive external air to enter the cabinet through the ventilation holes 24 on the ventilation side wall 23, and exchange heat with the heat exchanger assembly 220 before being discharged from the air outlet 211 to achieve a heat exchange function.

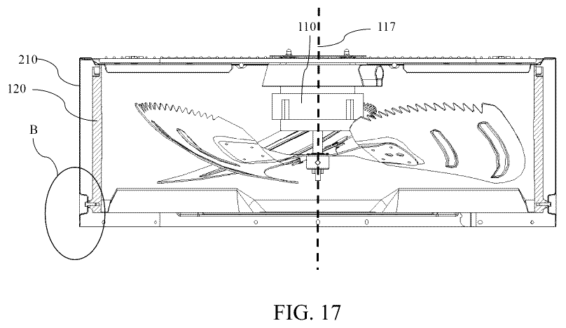

With reference to FIG. 17, in some embodiments of the present application, the air conditioner outdoor unit 200 further includes an electric control box assembly 240, which includes a partition 242, a circuit board 243 installed on the partition 242, and a cover 244 connected to the partition 242 and covering the circuit board 243.

The ventilation side wall 23 has a rectangular shape and forms an opening 25 at the corner. The bottom plate covers the opening 25 of the ventilation side wall 23. The cover 244 and the ventilation side wall 23 are configured into a complete rectangular shape.

It can be understood that the electric control box assembly 240 is a control part for the air conditioner outdoor unit 200. The circuit board 243 of the electric control box assembly 240 is fixed on the partition 242, and the cover 244 is also provided to protect the circuit board 243. The cover 244 covers the circuit board 243 and is fixed on the partition 242. The ventilation side wall 23 can have a square cylinder shape, with an opening formed at the corner for installing electric control units. The partition plate 242 and the ventilation side wall 23 can be fixed by snap-fit connection or bolt connection. The cover 244 covers the outer side of the circuit board 243 and matches an outer contour of the ventilation side wall 23 to ensure the continuity and integrity of the outer contour of the second housing 230.

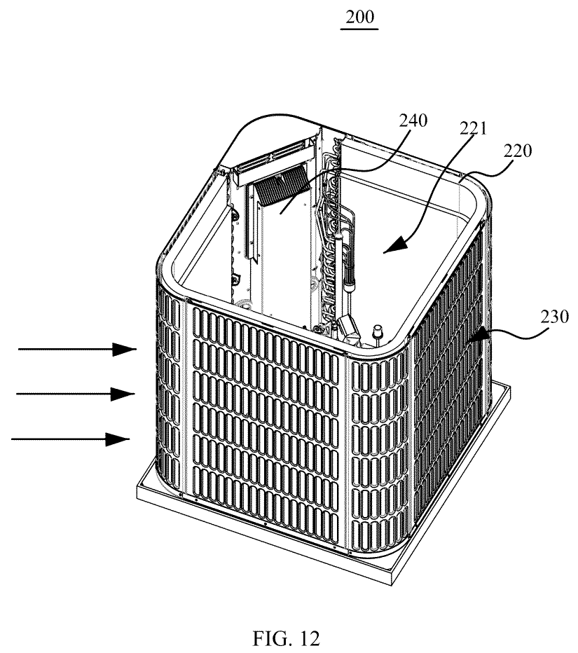

With reference to FIGS. 12 to 16, in some embodiments of the present application, a housing wall of the first housing 210 is recessed toward the inner cylindrical space to form multiple groove portions 13. Each of the groove portions 13 has a groove bottom wall 133 along the recessed direction, a first groove wall 131 connected to a lower side of the bottom wall, and a second groove wall 132 connected to an upper side of the bottom wall.

The first housing 210 is installed onto the second housing 230 from top to bottom, with the upper end of the second housing 230 inserted into the lower opening of the first housing 210 and the upper end of the second housing 230 configured as a bearing surface to bear the first groove walls 131 of the multiple groove portions 13.

It can be understood that part of the housing wall at the bottom end of the first housing 210 is recessed inward in the radial direction of the fan 110 to form the groove portion 13. The groove portion 13 can be arranged in an annular shape in the circumferential direction of the fan 110, or multiple groove portions 13 can be arranged at intervals in the circumferential direction of the fan 110. The first groove wall 131 and the second groove wall 132 of the groove portion 13 are arranged opposite each other and parallel to the radial direction of the fan 110. The first groove wall 131 and the second groove wall 132 are connected by the groove bottom wall 133. The upper end of the second housing 230 can be bent radially inward to form a bearing portion, which has a bearing surface facing the first housing 210. During installation, a side of the first groove wall 131 that faces the second housing 230 abuts against the bearing surface, and the second housing 230 can support the first housing 210. In order to ensure fixation, fixing holes can be arranged on the second housing 230, and the second housing 230 can be fixed to the first housing 210 by passing bolts through the fixing holes.

With reference to FIG. 16, in some embodiments of the present application, the lower edge of the first housing 210 is provided with multiple first fixing holes 14, and the upper end of the second housing 230 is provided with multiple second fixing holes 26. The multiple first fixing holes 14 are respectively fixed to the multiple second fixing holes 26 in a one-to-one correspondence.

It can be understood that the multiple first fixing holes 14 can be arranged on the lower edge of the first housing 210, with the axial direction of the first fixing holes 14 being the same as the radial direction of the fan 110, and the multiple second fixing holes 26 can be arranged on the lower edge of the second housing 230, with the axial direction of the second fixing holes 26 being the same as the radial direction of the fan 110. The first housing 210 and the second housing 230 can be fixedly installed by passing bolts through the first fixing holes 14 and the second fixing holes 26.

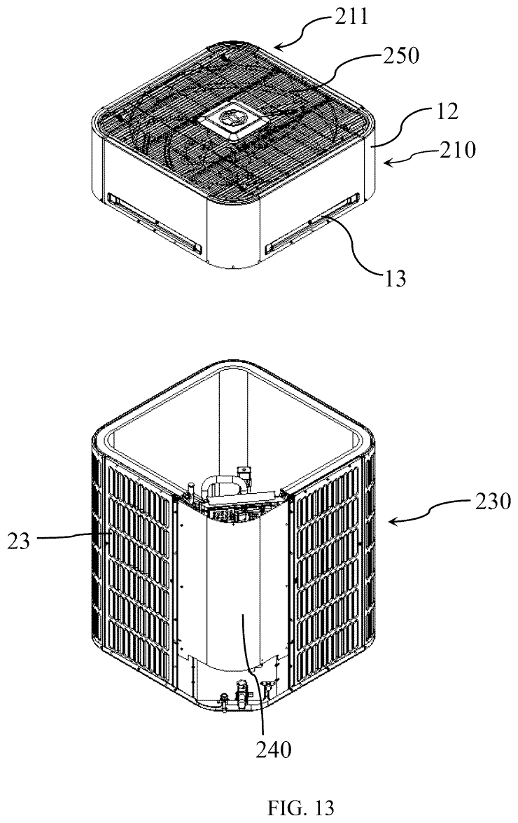

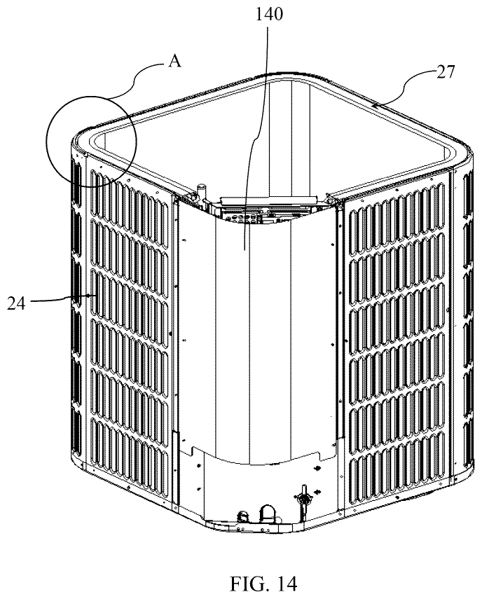

With reference to FIGS. 13, 16 and 18, in some embodiments of the present application, the fan unit 101 includes a flow guide member 120. An inner wall of the flow guide member 120 encloses a flow guide channel 121 with upper and lower openings. An outer side of the flow guide member 120 is provided with multiple side installation portions 156, and the groove bottom wall 133 of each groove portion 13 is correspondingly provided with at least one installation hole d129. The multiple side installation portions 156 are respectively fixed to the multiple installation holes 129 in a one-to-one correspondence.

It can be understood that the lower side of the flow guide member 120 can be fixedly connected to the groove portions 13. In one embodiment, at least one installation hole 129 can be provided on the groove bottom wall 133, i.e., on the side of the groove portion 13 that faces the fan 110. The side installation portions 156 can be provided at the lower end of the peripheral side of the flow guide member 120, and bolt holes can be provided on the side installation portions 156 and bolts can pass through the installation holes 129 and the bolt holes to fix the flow guide member 120 on the groove portions 13. With the fixation between the upper part of the flow guide member 120 and the support portions 16, the connection reliability of the flow guide member 120 can be further improved, and the flow guide member 120 is not easily shaken or deformed during use.

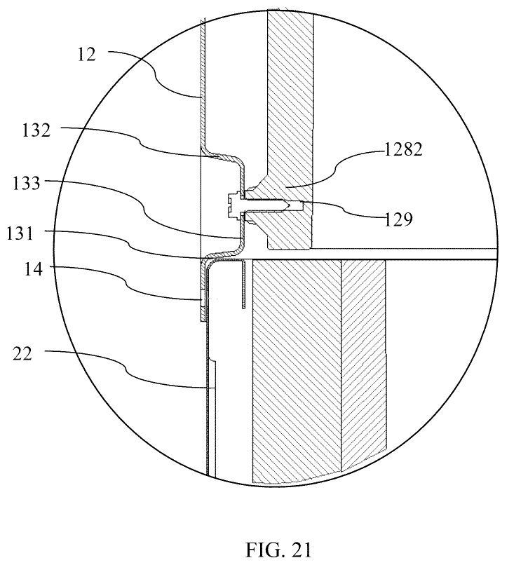

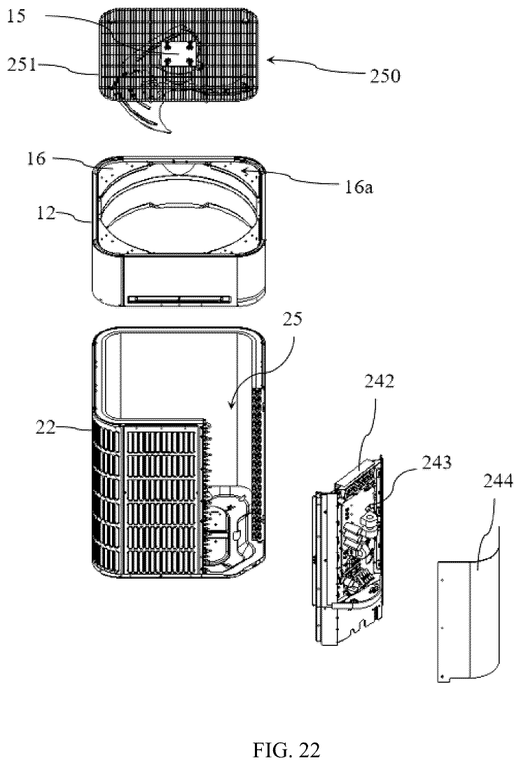

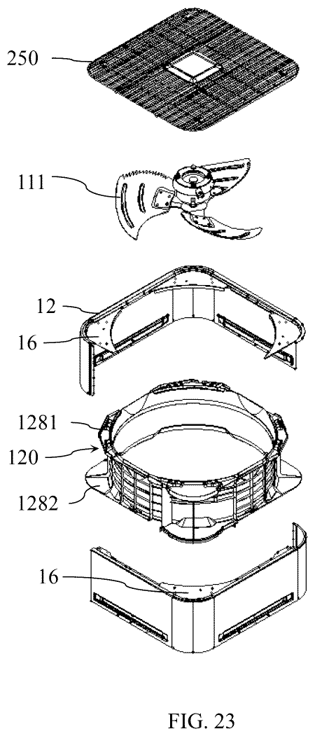

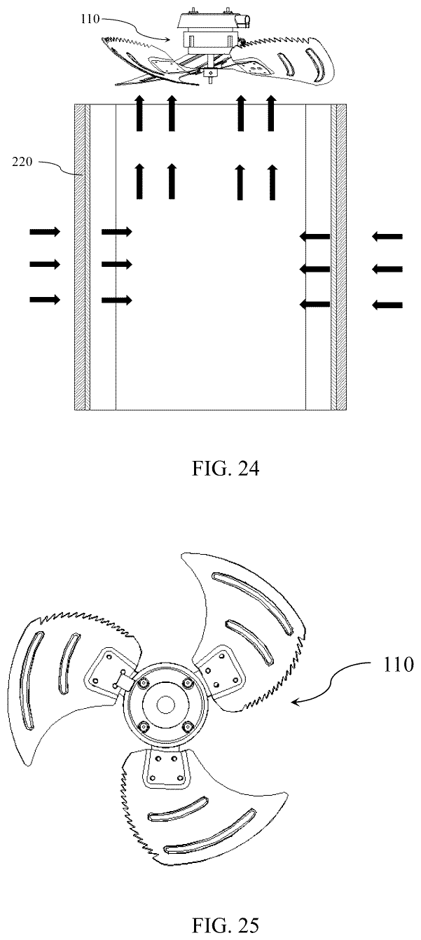

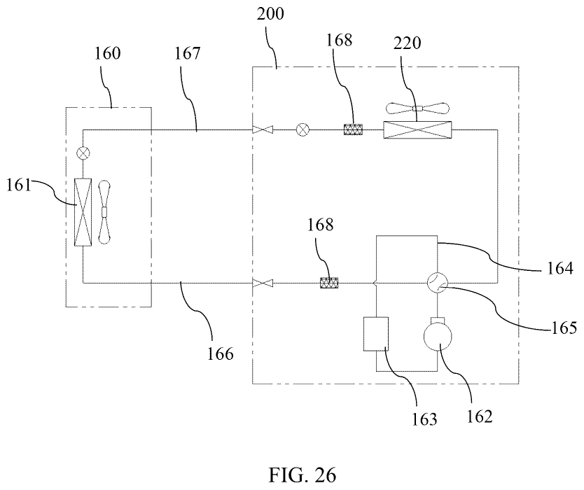

With reference to FIG. 21, the present application also provides an air conditioner, which includes the air conditioner outdoor unit 200 provided in the embodiments of the present application and an air conditioner indoor unit 160. The air conditioner indoor unit 160 and the air conditioner outdoor unit 200 are communicated through a gas pipe and a liquid pipe to form a refrigerant circulation system.

The air conditioner outdoor unit 200 includes a compressor 162, the heat exchanger assembly, and a gas-liquid separator 163; one end of the heat source side heat exchanger is connected to an exhaust port of the compressor 162, and the other end is connected to a liquid pipe 167; one end of the gas-liquid separator 163 is connected to an air return port of the compressor, and the other end of the gas-liquid separator 163 is connected to a gas pipe 166.

The air conditioner includes the air conditioner outdoor unit 200 according to any of the above embodiments, and further includes the compressor 162 and the gas-liquid separator 163 connected to the compressor 162. The compressor 162 and the gas-liquid separator 163 can be arranged at the bottom of the cabinet of the air conditioner outdoor unit 200 and located inside the heat exchange air duct 221. The compressor 162 is used to compress the refrigerant medium, and the compressed refrigerant medium flows in the heat exchanger assembly 220. Under the action of the fan 110 inside the air conditioner outdoor unit 200, the heat generated in the heat exchanger assembly 220 is cooled by the airflow in the flow guide channel 121, and the heat is carried to the outside of the air conditioner outdoor unit 200 by the airflow.

The air conditioner of the present application also includes the air conditioner indoor unit 160, in which an indoor heat exchanger 161 is arranged and communicated with the heat exchanger assembly 220 in the air conditioner outdoor unit 200 through the liquid pipe 167, and the refrigerant medium in the heat exchanger assembly 220 of the air conditioner outdoor unit 200 can circulate to the indoor heat exchanger 161 of the air conditioner indoor unit 160 and exchange heat with the indoor air, maintaining the indoor temperature within a reasonable range. In a cooling mode, the heat exchanger assembly 220 in the air conditioner outdoor unit 200 is communicated with the exhaust port of the compressor 162, condensing the refrigerant coming out of the compressor; the indoor heat exchanger 161 in the air conditioner indoor unit 160 serves as an evaporator; after passing through the evaporator, the indoor air exchanges heat with the refrigerant, and the air is cooled and blown out to the indoor space through a blow-out port of the air conditioner indoor unit 160. In a heating mode, the air conditioner indoor unit 160 is communicated with the exhaust port of the compressor 162 through the gas pipe 166, and the high-temperature refrigerant passes through the indoor heat exchanger 161 to exchange heat with the indoor air, thereby heating the indoor air. The compressor 162 can be a jet type enthalpy increasing compressor, which has an air return pipe 164. The compressor 162 performs air compressing and jetting simultaneously through the air return pipe 164 and a four-way valve 165 to realize mixed cooling, achieving enthalpy increasing effect. The gas-liquid separator 163 is arranged on the air return pipe 164 for gas-liquid separation of the return air. In addition, filters 168 are arranged on the gas pipe 166 and the liquid pipe 167 respectively to filter gas and liquid, improving the reliability of the entire machine.

Described above are only some embodiments of the present application, but the scope of protection of the present application is not limited to this. Any changes or replacements that can be easily conceived within the scope disclosed by the present application should be covered within the scope of protection of the present application. Therefore, the scope of protection of the present application should be accorded with the scope of protection of the claims.

What is claimed is:

1. An air supply assembly, comprising:
a fan, which comprises at least one fan blade having a rear edge and an outer edge; wherein the outer edge is located on a side of the fan blade that is away from a rotational axis of the fan, and the rear edge is connected to the outer edge, the rear edge locating at the rearside of the fan blade along the rotational direction of the fan, and having a disturbing structure;
a flow guide member having a flow guide channel; wherein the flow guide member is sleeved outside of the fan and the fan is provided in the flow guide channel, an inner wall of at least a part of the flow guide channel has a straight cylinder shape, and has a preset gap with the outer edge; the preset gap is used to define movement of an airflow formed on the fan blade in a radial direction of the flow guide channel, and at least a part of the vortex disturbing structure is accommodated in the part of the flow guide channel that has the straight cylinder shape.

2. The air supply assembly according to claim 1, wherein the vortex disturbing structure comprises multiple concave portions and multiple convex portions, which are arranged alternately in an extending direction of the rear edge.

3. The air supply assembly according to claim 2, wherein in a direction of the rotational axis of the fan, the concave portions and the convex portions have a height difference, and all of the multiple concave portions are accommodated in the part of the flow guide channel that has the straight cylinder shape.

4. The air supply assembly according to claim 2, wherein the vortex disturbing structure is configured into a serrated shape.

5. The air supply assembly according to claim 1, wherein in a direction of the rotational axis of the fan, the length of the vortex disturbing structure is L1, and the length of the vortex disturbing structure accommodated in the part of the flow guide channel that has the straight cylinder shape is L2, wherein L2/L1 is larger than 0.8.

6. The air supply assembly according to claim 1, wherein the fan blade has a first end and a second end in a direction of the rotational axis of the fan; and
the first end is located in an edge area at one end of the straight cylinder-shaped flow guide channel, and the second end is located in an edge area at the other end of the straight cylinder-shaped flow guide channel.

7. The air supply assembly according to claim 1, wherein the preset gap is any value between 5 mm and 15 mm.

8. The air supply assembly according to claim 1, wherein the flow guide channel comprises an inlet section, an outlet section, and a middle section; the middle section is located between the inlet section and the outlet section, and is configured into a straight cylinder shape; in a direction from the inlet section to the outlet section, an inner diameter of the outlet section gradually increases, and in the direction from the inlet section to the outlet section, an inner diameter of the inlet section gradually decreases.

9. The air supply assembly according to claim 8, wherein the outlet section is provided with a first noise reduction structure, and most of the vortex disturbing structure which is configured to be serrated shape is accommodated in the middle section.

10. The air supply assembly according to claim 9, wherein the inlet section is provided with a second noise reduction structure.

11. The air supply assembly according to claim 1, wherein an outer wall of the flow guide member is provided with reinforcing ribs.

12. The air supply assembly according to claim 11, wherein the reinforcing ribs comprise multiple transverse ribs and multiple longitudinal ribs; the multiple transverse ribs are spaced apart in a direction of the rotational axis of the fan, the multiple longitudinal ribs are spaced apart in a circumferential direction of the flow guide member, and the transverse ribs and the longitudinal ribs intersect on the outer wall of the flow guide member.

13. An air conditioner outdoor unit, comprising:
a first housing, which is provided with a first air outlet and a first air inlet, the first air outlet being provided at the top of the housing; and
the air supply assembly according to claim 1, the air supply assembly being provided inside the first housing and having a rotational axis, and the air supply assembly having an air outlet that is arranged opposite to the first air outlet.

14. The air conditioner outdoor unit according to claim 13, wherein the air conditioner outdoor unit further comprises a heat exchanger assembly which is provided below the first housing; the heat exchanger assembly encloses a heat exchange air duct, and the heat exchange air duct is communicated with the first air inlet.

15. The air conditioner outdoor unit according to claim 14, wherein the air conditioner outdoor unit further comprises:
a second housing, the heat exchanger assembly being provided inside the second housing and arranged along at least a side circumferential wall of the second housing and an opening the being provided at the corner of the second housing; and
an electric control box assembly, which is mounted at the open, and which encloses the heat exchange air duct together with the heat exchanger assembly.

16. The air conditioner outdoor unit according to claim 15, wherein the air conditioner outdoor unit further comprises:
a mesh cover, which is arranged at the first air outlet of the first housing, and which has a grille structure that is arranged opposite to the fan; and
the air supply assembly further comprises a driving assembly, which is connected to the grille structure, a driving shaft of the driving assembly being connected to the fan.

17. The air conditioner outdoor unit according to claim 16, wherein the first housing comprises a first side wall portion arranged around the rotational axis, which is configured to be the inner wall of the flow guide channel with upper and lower openings along the rotational axis; the upper opening of the first side wall portion is configured as the air outlet, and the lower opening of the first side wall portion is configured to receive air after heat exchange with the heat exchanger assembly; and
the mesh cover is installed at the upper opening of the first side wall portion, a lower side of the mesh cover faces the flow guide channel defined by the first side wall portion, and the fan is installed on the lower side of the mesh cover, wherein the first side wall portion comprises multiple support portions, which are arranged at the upper opening of the first side wall portion, and which are configured to jointly support the mesh cover; and
the multiple support portions are located at a same first plane, which is perpendicular to the rotational axis; the first plane is lower than an upper edge of the first side wall portion to form a concave space, and the grille structure is accommodated in the concave space and fixedly installed on the multiple support portions, and wherein an inner wall of the flow guide member encloses the flow guide channel with upper and lower openings, and an edge of the upper opening of the flow guide member is formed with multiple upper installation portions; and
the first side wall portion comprises multiple support portions, which are arranged at the upper opening of the first side wall portion; lower sides of the multiple support portions are correspondingly fixed to the multiple upper installation portions respectively, and upper sides of the multiple support portions are configured to jointly support the mesh cover.

18. The air conditioner outdoor unit according to claim 17, wherein the second housing comprises a second side wall portion arranged around the rotational axis, which is configured in a cannular configuration with upper and lower openings along the rotational axis; a bottom wall is installed at the lower opening of the second side wall portion, and the bottom wall supports the heat exchanger assembly; the upper opening of the second side wall portion corresponds to the lower opening of the first side wall portion, wherein the second side wall portion has a ventilation side wall, which surrounds an outer side of the heat exchanger assembly and which has multiple ventilation holes corresponding to the heat exchanger assembly; the air supply assembly drives external air to pass through the multiple ventilation holes and exchange heat with the heat exchanger assembly, and the air after heat exchange enters the air supply assembly and flows out from the air outlet, and wherein the air conditioner outdoor unit further comprises the electric control box assembly, which comprises a partition, a circuit board installed on the partition, and a cover connected to the partition and covering the circuit board; and
the ventilation side wall has a rectangular shape and forms an opening at the corner; the partition covers the opening of the ventilation side wall, and the cover and the ventilation side wall are configured into a complete rectangular shape.

19. The air conditioner outdoor unit according to claim 15, wherein a housing wall of the first housing is recessed toward the internal cylindrical space to form multiple groove portions, each of the groove portions having a groove bottom wall along the recessed direction, a first groove wall connected to a lower side of the groove bottom wall, and a second groove wall connected to an upper side of the groove bottom wall; and
the first housing is installed onto the second housing from top to bottom, and an upper end of the second housing is inserted into the lower opening of the first housing and is configured as a bearing surface to bear the first groove walls of the multiple groove portions, wherein a lower edge of the first housing is provided with multiple first fixing holes, the upper end of the second housing is provided with multiple second fixing holes, and the multiple first fixing holes are respectively fixed to the multiple second fixing holes in a one-to-one correspondence, and wherein an inner wall of the flow guide member encloses the flow guide channel with upper and lower openings, and an outer side of the flow guide member is provided with multiple side installation portions; the groove bottom wall of each of the groove portions is correspondingly provided with at least one installation hole, and the multiple side installation portions are respectively fixed to the multiple installation holes in a one-to-one correspondence.

20. An air conditioner, which comprises the air conditioner outdoor unit according to claim 14 and an indoor unit, and the indoor unit and the air conditioner outdoor unit are communicated through a gas pipe and a liquid pipe to form a refrigerant circulation system; and
the air conditioner outdoor unit comprises a compressor, the heat exchanger assembly, and a gas-liquid separator; one end of the heat exchanger assembly is connected to an exhaust port of the compressor, and the other end of the heat exchanger assembly is connected to the liquid pipe; one end of the gas-liquid separator is connected to an air return port of the compressor, and the other end of the gas-liquid separator is connected to the gas pipe.
